(19) United States
(12) Patent Application Publication
(10) Pub. No.: US 2025/0182721 A1
(43) Pub. Date: Jun. 5, 2025

(54) KEY FOR KEYBOARD APPARATUS

(71) Applicant: YAMAHA CORPORATION, Hamamatsu-shi (JP)

(72) Inventors: Tadaharu KATO, Hamamatsu-shi (JP); Masayuki SATOMI, Hamamatsu-shi (JP)

(21) Appl. No.: 18/960,225

(22) Filed: Nov. 26, 2024

(30) Foreign Application Priority Data
Dec. 5, 2023 (JP) 2023-205585

(51) Int. Cl. G10C 3/12

(52) U.S. Cl. CPC G10C 3/12

(57) ABSTRACT

A key for a keyboard apparatus according to an embodiment of the present disclosure, the key includes: a key body portion made of wood; a key upper surface portion made of resin positioned on an upper surface of the key body portion; and an adhesive material bonding the key body portion and the key upper surface portion, wherein a lower surface of the key upper surface portion includes a recess portion including a plurality of recesses, wherein each recess has an uneven shape.

### CROSS REFERENCE TO RELATED APPLICATIONS

This application claims the benefit of priority to Japanese Patent Application No. 2023-205585, filed on Dec. 5, 2023, the entire contents of which are incorporated herein by reference.

### FIELD

An embodiment of the present disclosure relates to a key for a keyboard apparatus.

### BACKGROUND

In general, in keyboard apparatuses such as acoustic pianos and electronic pianos, a key in which a resin material is attached to an upper surface of a key body of wood or a key in which wood is attached to side portions of a key body of a resin material is used (Japanese Laid-Open Patent Publication No. 2014-066816 and Japanese Laid-Open Patent Publication No. 2023-050818). If the attached resin material and the wood are separated from each other, not only the appearance of the piano is impaired but also the performance of the user (player) may be hindered. Therefore, it is necessary to prevent peeling between the wood and the resin material.

In recent years, in consideration of the environment, there has been a need to use a water-soluble adhesive (for example, a wood glue) instead of an organic solvent-based (polyurethane-based) adhesive when bonding wood and a resin material. However, a flatness of a surface of the resin material is very high, and since the wood glue does not enter the inside of the resin material, sufficient adhesive force cannot be obtained. As a result, interfacial fracture occurs between the resin material and the adhesive, and there is a problem that the resin material is peeled off from the wood. Conventionally, in order to improve the adhesive strength between the wood glue and the resin material, although measures have been made to apply file processing or embossing by a mold on the surface of the resin material, sufficient adhesive strength has not been obtained.

### SUMMARY

A key for a keyboard apparatus according to an embodiment of the present disclosure, the key includes: a key body portion made of wood; a key upper surface portion made of resin positioned on an upper surface of the key body portion; and an adhesive material bonding the key body portion and the key upper surface portion, wherein a lower surface of the key upper surface portion includes a recess portion including a plurality of recesses, wherein each recess has an uneven shape.

A key for a keyboard apparatus according to an embodiment of the present disclosure includes: a key body portion made of wood; a key upper surface portion made of resin positioned on an upper surface of the key body portion; and an adhesive material bonding the key body portion and the key upper surface portion, wherein a lower surface of the key upper surface portion includes: a visible region that is visible as viewed from the lower side of the key upper surface portion; and a non-visible region that is positioned overlapping the visible region and thus not visible as viewed from the lower side of the key upper surface portion.

### BRIEF DESCRIPTION OF DRAWINGS

FIG. 1 is a perspective view showing an external appearance of a keyboard apparatus according to an embodiment of the present disclosure.

FIG. 2 is a side view showing an action mechanism of a keyboard apparatus according to an embodiment of the present disclosure.

FIG. 3 is a side view of a key and an enlarged view of a portion thereof in an embodiment of the present disclosure.

FIG. 4 is a partially enlarged view of the dotted line frame of FIG. 3.

FIG. 5 is a partially enlarged view of the dotted line frame of FIG. 4.

FIG. 6 is a diagram showing a laser irradiation portion of a top surface material of a key according to an embodiment of the present disclosure.

FIG. 7 is a partially enlarged view of a laser irradiation portion of a top surface material of a key according to an embodiment of the present disclosure.

FIG. 8 is a cross-sectional view of a laser irradiated portion of a top surface material of a key according to an embodiment of the present disclosure.

FIG. 9 is a partially enlarged view of a laser irradiation portion of a top surface material of a key according to a modification of an embodiment of the present disclosure.

FIG. 10 is a diagram showing a laser irradiation portion of a top surface material of a key according to a modification of an embodiment of the present disclosure.

FIG. 11 is a perspective view of a key according to a modification of an embodiment of the present disclosure.

### DESCRIPTION OF EMBODIMENTS

Hereinafter, a key for a keyboard apparatus according to an embodiment of the present disclosure will be described in detail with reference to the drawings. The following embodiments are examples of embodiments of the present disclosure, and the present disclosure is not to be construed as being limited to these embodiments. In the drawings referred to in the present embodiment, the same or similar parts are denoted by the same reference signs or similar reference signs, and repetitive description thereof may be omitted. Dimensional ratios (ratios between components, ratios in the vertical and horizontal height directions, and the like) in the drawings may be different from actual ratios for convenience of explanation, and a part of the configuration may be omitted from the drawings. In the following description, based on the vertical direction in each drawing, although expressions such as “upper”, “above”, “upper end”, “lower”, “downward”, and “lower end” may be used, these vertical directions merely describe relative directional relationships, the vertical direction may be reversed.

One object of an embodiment of the present disclosure is to improve the adhesive strength between wood and a resin material in a key for bonding the wood and the resin material.

### [1. Overall Configuration of Keyboard Apparatus 10]

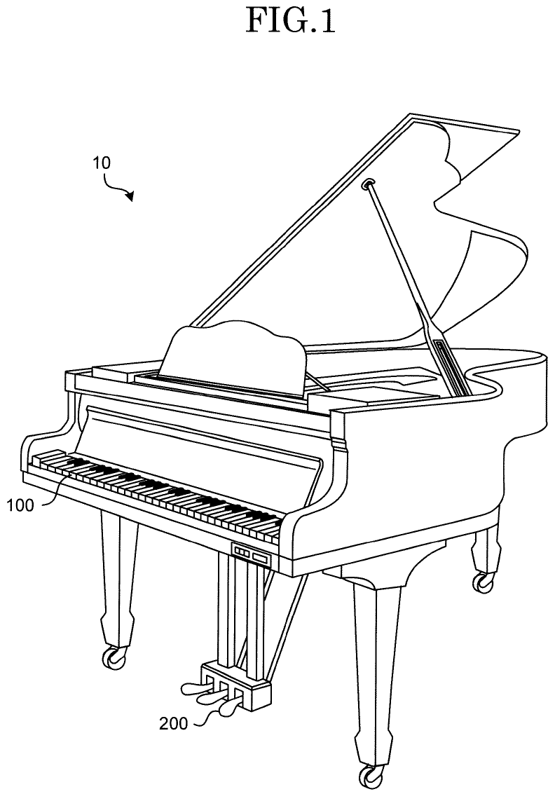

FIG. 1 is a perspective view showing an external appearance of a keyboard apparatus 10 according to an embodiment of the present disclosure. The keyboard apparatus 10 includes a keyboard in which a plurality of keys 100 are arranged and a pedal 200. The keys 100 and the pedal 200 are provided on the front surface of the keyboard apparatus 10. When a player operates the keys 100 and the pedal 200, performance is performed. In FIG. 1, although a grand piano is shown as an example of the keyboard apparatus 10, the keyboard apparatus 10 according to the present embodiment is not limited to the grand piano, and may be an upright piano or an electronic piano. Although there are a plurality of pedals of the keyboard apparatus 10, the pedal 200 indicates a damper pedal.

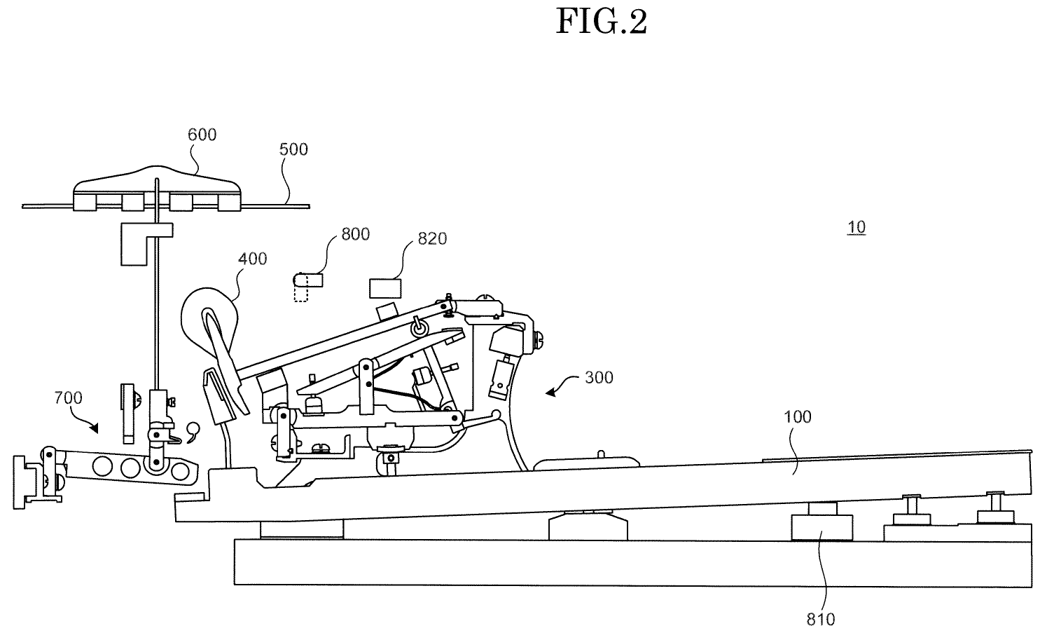

FIG. 2 is a side view showing an action mechanism of the keyboard apparatus according to an embodiment of the present disclosure. In FIG. 2, a configuration of one white key 100 among the plurality of keys 100 provided in the keyboard apparatus 10 is exemplified. Other white keys and black keys have the same configuration as that of FIG. 2, and thus description thereof will be omitted. As shown in FIG. 2, the keyboard apparatus 10 includes the white key 100, an action mechanism 300, a hammer 400, a string 500, a damper 600, and a damper operation mechanism 700.

The action mechanism 300 and the hammer 400 are provided corresponding to the respective white keys 100. When the white key 100 is pressed, a force is transmitted through the action mechanism 300, and the hammer 400 moves to hit the string 500 provided corresponding to the white key 100. The string 500 is a sound generating body that generates sound by hitting of the hammer 400. When the string 500 is hit, the string 500 vibrates at a vibration frequency corresponding to each white key 100. The damper 600 is moved by the damper operation mechanism 700. The damper operation mechanism 700 controls a contact state or a non-contact state between the damper 600 and the string 500 in accordance with a depression amount of the white key 100 and a depression amount of the pedal 200. When the damper 600 comes into contact with the string 500, the vibration of the string 500 stops and the sound is stopped.

The keyboard apparatus 10 includes a stopper 800, a key sensor 810, and a hammer sensor 820 in addition to the members described above. The stopper 800 is a member that collides with a hammer shank and restricts upward rotation of the hammer 400. The key sensor 810 is provided below the white key 100, and outputs a detection signal corresponding to a behavior of the white key 100 to a control device. For example, the key sensor 810 detects a depression amount of the white key 100 with a continuous amount (or fine resolution), and outputs a detection signal indicating the detection result to the control device. The hammer sensor 820 is provided corresponding to each hammer 400, and outputs a detection signal corresponding to a behavior of the hammer 400 to the control device. For example, the hammer sensor 820 detects a moving speed of the string 500 immediately before hitting by the hammer 400, and outputs a detection signal indicating the detection result to the control device. The control device specifies a hitting timing (the timing of the key on) and a hitting speed (the velocity) of the hammer 400 with respect to the string 500 corresponding to each white key 100 (the key number) based on the detection signals from the key sensor 810 and the hammer sensor 820.

### [2. Structure of Key]

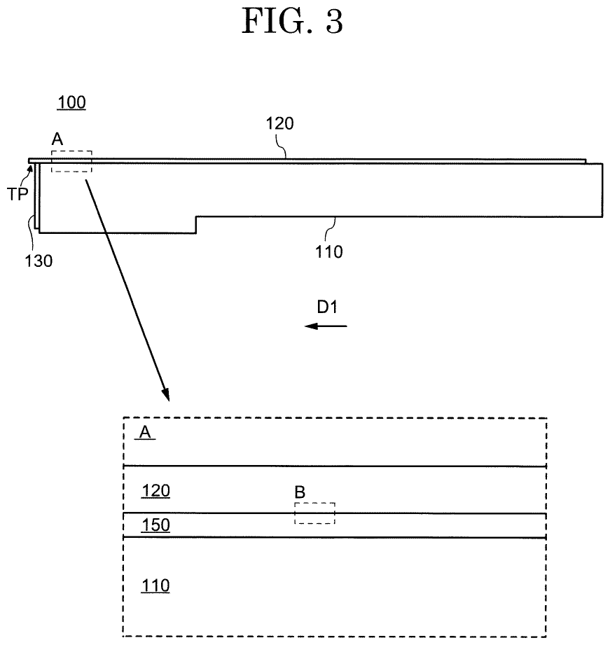

FIG. 3 is a side view of a key and an enlarged view of a portion thereof in an embodiment of the present disclosure. As shown in FIG. 3, the white key 100 includes a key body portion 110, a key upper surface portion 120, and a key front surface portion 130. The key body portion 110 is wood. The key upper surface portion 120 and the key front surface portion 130 are made of a resin material. The key upper surface portion 120 is provided on an upper surface of the key body portion 110. The key front surface portion 130 is provided on a front surface (an end surface in a direction D1) of the key body portion 110. The key upper surface portion 120 and the key front surface portion 130 are bonded to the key body portion 110 using, for example, a water-soluble adhesive such as a vinyl acetate resin-based emulsion adhesive (wood glue).

Thicknesses of the key upper surface portion 120 and the key front surface portion 130 are 1 mm or more and 3 mm or less, or 1.5 mm or more and 2.0 mm or less. Therefore, a method for performing uneven processing on the key upper surface portion 120 and the key front surface portion 130 is limited by the thickness described above. For example, acryl resin (PMMA resin), ABS resin, AS resin, and unsaturated polyester resin are used as the key upper surface portion 120 and the key front surface portion 130. The key upper surface portion 120 and the key front surface portion 130 may be the same member or different members. For example, the PMMA resin may be used as the key upper surface portion 120, and the ABS resin may be used as the key front surface portion 130.

The key upper surface portion 120 extends beyond a front end (an end in the direction D1) of the key body portion 110 and protrudes beyond the key front surface portion 130 in the direction D1. The protruding portion may be referred to as a protruding portion TP. The protruding portion TP protrudes from the front surface (the surface on the direction D1 side) of the key front surface portion 130 by 1 mm or more and 5 mm or less, or by 1.5 mm or more and 3 mm or less.

As shown in a partially enlarged view “A” of FIG. 3, an adhesive layer 150 is provided between the key body portion 110 and the key upper surface portion 120. The adhesive layer 150 is in contact with a lower surface of the key upper surface portion 120. The adhesive layer 150 is a water-soluble adhesive. For example, as the adhesive layer 150, the wood glue is used as described above. The wood glue is a water-soluble adhesive containing a vinyl acetate resin as a component. Moisture contained in the wood glue is absorbed by the wood or evaporated from the wood, thereby solidifying the wood glue. Wood is porous and has a very complex uneven shape formed on its surface. When the water-soluble adhesive is used for bonding the wood, the water-soluble adhesive is solidified in a state where the water-soluble adhesive penetrated into an inside of the uneven shape of the wood. Thus, the water-soluble adhesive provides strong adhesion to the wood. On the other hand, since a surface of the resin material is flat, the water-soluble adhesive cannot penetrate into an inside thereof. Therefore, the water-soluble adhesive cannot provide strong adhesion to the resin material.

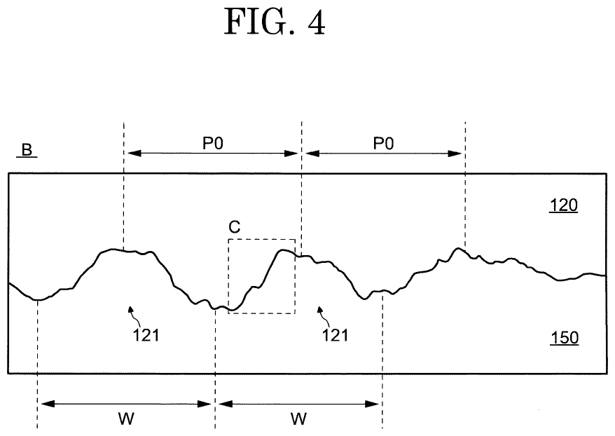

FIG. 4 is a partially enlarged view of the dotted line frame “B” in FIG. 3. As shown in FIG. 4, a plurality of recesses 121 are provided on the lower surface of the key upper surface portion 120. A width W of the recess 121 is 20 μm or more and 500 μm or less, 50 μm or more and 300 μm or less, 50 μm or more and 200 μm or less, or 75 μm or more and 150 μm or less. A depth of the recess 121 is 20 μm or more, 30 μm or more, or 40 μm or more. The recesses 121 are periodically provided in intervals PO. Periodicity of the recesses 121 can be evaluated by performing a Gaussian fitting on shapes of the recesses 121 and measuring distances between the vertices of profiles after fitting. Further, an uneven shape is formed inside the recess 121. Details of the uneven shape will be described later.

As will be described in detail later, a region of the lower surface of the key upper surface portion 120 where the recess 121 is not provided (a region sufficiently separated from the recess 121) is flat. A depth of the recess 121 is a depth with respect to a flat surface of the lower surface of the key upper surface portion 120. In FIG. 4, a shape protruding downward may be formed between the adjacent recesses 121 when the recesses 121 are formed. Therefore, when the depth of the recess 121 is evaluated, the evaluation is performed on the basis of the flat lower surface of the key upper surface portion 120 as described above.

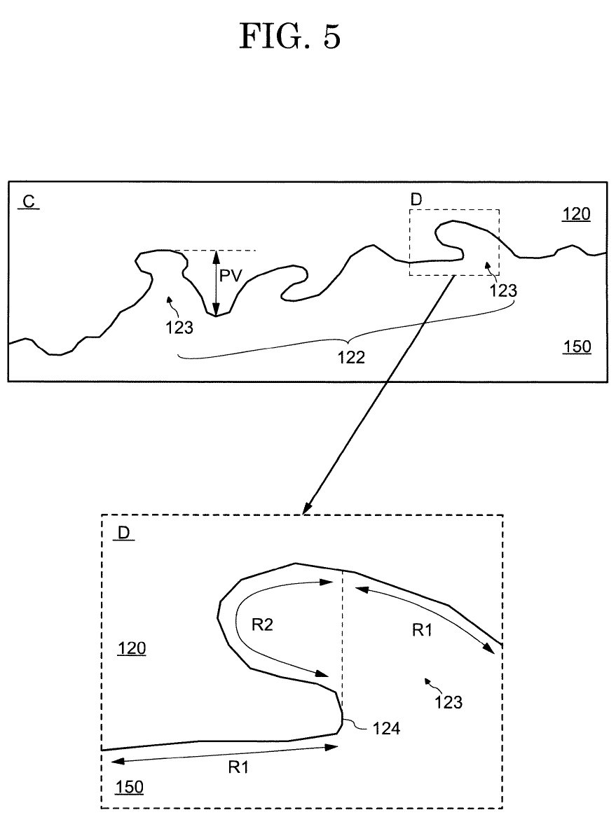

FIG. 5 is a partially enlarged view of the dotted line frame “C” in FIG. 4. The enlarged view shown in FIG. 5 is an enlarged view of a portion of the recess 121 of FIG. 4. In FIG. 4, although an inside of the recess 121 is displayed as a small step for convenience of explanation, actually, uneven shapes 122 having large steps is formed in the inside of the recess 121 as shown in FIG. 5. For example, a height difference PV of at least a part of the uneven shapes 122 is 20 μm or more. As shown in FIG. 5, the uneven shapes 122 formed in the recesses 121 are not periodically arranged like the recesses 121, but are irregularly arranged.

In a partially enlarged view “D” of FIG. 5, one recess shape 123 and one convex shape 124 of the uneven shapes 122 are enlarged and displayed. As shown in FIG. 5, an undercut shape is formed by the recess shape 123 and the convex shape 124. That is, in the key upper surface portion 120 of the recess shape 123, a visible region R1 and a non-visible region R2 are present when viewed from the underside (lower) of the key upper surface portion 120 (when viewed from the key body portion 110 side). With such a shape, even when an external force in a direction in which the adhesive layer 150 moves away the key upper surface portion 120 is applied to the adhesive layer 150, since the adhesive layer 150 formed on the region R2 is locked to the convex shape 124, the adhesive layer 150 is prevented from being peeled off from the key upper surface portion 120. That is, the adhesive layer 150 is firmly bonded to the key upper surface portion 120 by an anchor effect due to the undercut shape. In the key upper surface portion 120, a portion in the region R1 may be referred to as a “first portion”, and a portion in the region R2 may be referred to as a “second portion”.

A plurality of undercut shapes similar to the recess shape 123 and the convex shape 124 are provided on the lower surface of the key upper surface portion 120. Since the anchor effect is exerted by each of the plurality of undercut shapes, adhesive strength between the adhesive layer 150 and the key upper surface portion 120 can be improved.

### [3. Method for Forming Recess 121 and Uneven Shape 122]

Formation of the recess 121 and the uneven shape 122 shown in FIG. 4 and FIG. 5 is realized by performing laser irradiation with low power to the lower surface of the key upper surface portion 120. Output of a laser beam used for laser irradiation is, for example, 1 W or more and 100 W or less, 5 W or more and 50 W or less, or 10 W or more and 20 W or less. As a laser irradiation apparatus, an apparatus that continuously irradiates a laser beam may be used, or an apparatus that periodically irradiates a laser beam may be used. In the case where a laser irradiation apparatus that periodically irradiates a laser beam is used, for example, the laser beam may be irradiated at a period corresponding to frequency of 10 KHz or more and 50 KHz or less or 20 KHz or more and 30 KHz or less. A scanning rate of the laser beam is 500 mm/sec or more and 3000 mm/sec or less, and 1000 mm/sec or more and 2200 mm/sec or less.

For example, in a laser irradiation apparatus that processes metal, output of the laser beam is larger than 100 W. However, when a resin material such as the key upper surface portion 120 is processed using such a high-power laser apparatus, resin in a region irradiated with laser light is completely melted or carbonized, so that an undercut shape as shown in FIG. 5 cannot be obtained. Therefore, in the present embodiment, in order to obtain the undercut shape, the laser beam is irradiated to the key upper surface portion 120 with the output in the numerical range described above. As such a laser irradiation apparatus, a laser marker apparatus is used. The laser marker apparatus scrapes or melts only the outermost layer of a member to be processed, and thus irradiates a laser beam with a much weaker output than the laser irradiation apparatus for processing.

In the conventional file processing or embossing, since only a recess shape having a forward tapered shape can be formed, an undercut shape as shown in FIG. 5 cannot be obtained. Further, as described above, when the laser irradiation apparatus for processing is used, it was not possible to obtain the undercut shape even if the output of the laser beam is reduced. However, by using a laser marker apparatus for processing, in which output is smaller than the laser irradiation apparatus for processing, and processes only the outermost layer of the object, as described above, it was possible to form an undercut shape on the lower surface of the key upper surface portion 120. The adhesive strength between the key upper surface portion 120 and the adhesive layer 150 is improved by forming the undercut shape.

### [4. Unevenness Forming Region 125]

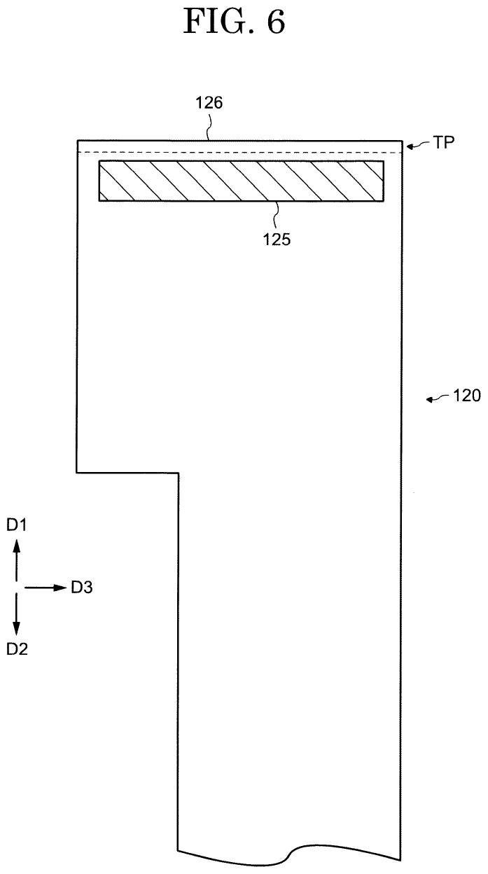

FIG. 6 is a diagram showing a laser irradiation portion of a top surface material of a key according to an embodiment of the present disclosure. As shown in FIG. 6, an unevenness forming area 125 is provided near a tip 126 of the key upper surface portion 120 in the direction D1. The unevenness forming region 125 is provided with the recess 121 and the uneven shape 122 shown in FIG. 4 and FIG. 5. The unevenness forming region 125 is provided only in a region along the tip 126 of the key upper surface portion 120.

In FIG. 6, a region on the tip 126 side from a dotted line displayed near the tip 126 (a region on the direction D1 side of the dotted line) is a region in which the key upper surface portion 120 protrudes in the direction D1 than the key body portion 110. The unevenness forming regions 125 are provided on a direction D2 side of the dotted line. The unevenness forming region 125 is provided 3 mm or more away from the dotted line on the direction D2 side. That is, a distance between an end in the direction D1 and the tip 126 of the unevenness forming region 125 is 3 mm or more. As shown in FIG. 3, although a part of the lower surface of the key upper surface portion 120 is exposed to the outside, the recess 121 and the uneven shape 122 are not formed in the region exposed to the outside.

As shown in FIG. 3, a vicinity of the tip of the key upper surface portion 120 protrudes toward the direction D1. Therefore, a finger of the user performing the keyboard apparatus may come into contact with the vicinity of the tip of the key upper surface portion 120. In particular, when the finger of the user collides with the vicinity of the tip of the key upper surface portion 120 from below, a force in a direction in which the key upper surface portion 120 separates from the key body portion 110 is applied to the key upper surface portion 120 due to the collision. However, since the unevenness forming region 125 is provided in the vicinity of the tip of the key upper surface portion 120, even if such the force is applied to the key upper surface portion 120, it is possible to prevent the key upper surface portion 120 from being separated from the key body portion 110.

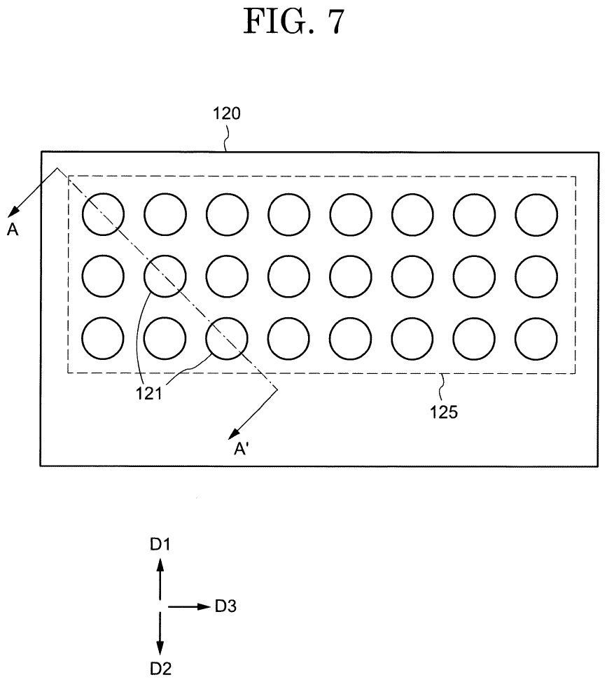

FIG. 7 is a partially enlarged view of a laser irradiation portion of a top surface material of a key in an embodiment of the present disclosure. FIG. 7 is an enlarged view of a part of the unevenness forming region 125 of FIG. 6. As shown in FIG. 7, in the unevenness forming region 125, the plurality of recesses 121 are periodically arranged in a plan view. In the embodiment shown in FIG. 7, although the plurality of recesses 121 are arranged at equal intervals in the direction D1 and a direction D3, a distance between the recesses 121 adjacent in the direction D1 and a distance between the recesses 121 adjacent in the direction D3 may be different. The cross-sectional shape of each of the plurality of recesses 121 is the same as that of FIG. 4 and FIG. 5.

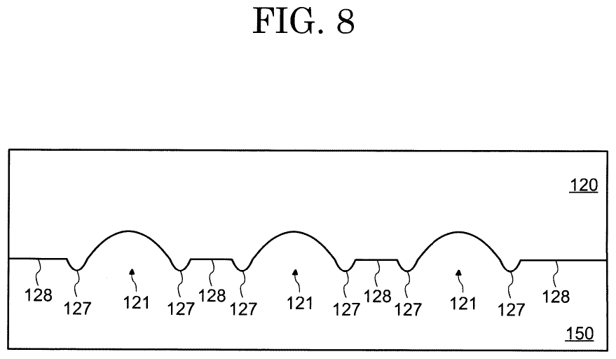

FIG. 8 is a cross-sectional view of a laser irradiated portion of a top surface material of a key according to an embodiment of the present disclosure. The cross-sectional view shown in FIG. 8 is a cross-sectional view taken along a line A-A′ of FIG. 7. Although the cross-sectional view shown in FIG. 8 is simplified for convenience of explanation, the actual cross-sectional shape is the same as the cross-sectional view shown in FIG. 4 and FIG. 5. In FIG. 8, a shape of an edge portion of the recess 121 and a shape of an outside of the recess 121 will be mainly described.

As shown in FIG. 8, an edge portion 127 of the recess 121 protrudes downward. The edge portion 127 is provided around the recess portion 121. It is considered that a protruding shape of the edge portion 127 is formed by movement of a resin material originally present in the recess 121 when the recess 121 is formed by the laser irradiation. In the region outside the edge portion 127, the lower surface of the key upper surface portion 120 is flat. In other words, an uneven shape is provided on a part of the lower surface of the key upper surface portion 120, and in the other portions, the lower surface of the key upper surface portion 120 is flat.

As described above, according to the white key 100 of the present embodiment, even if the water-soluble adhesive (the adhesive layer 150) is used for bonding the wood material (the key body portion 110) and the resin material (the key upper surface portion 120), the adhesive strength between the materials can be improved. Even if an organic solvent-base adhesive is used as the adhesive layer 150, the adhesive strength is improved by the undercut shape of the resin material.

According to an embodiment of the present disclosure, in a key in which wood and a resin material are bonded, the bonding strength between the wood and the resin material can be improved.

### [5. Modification]

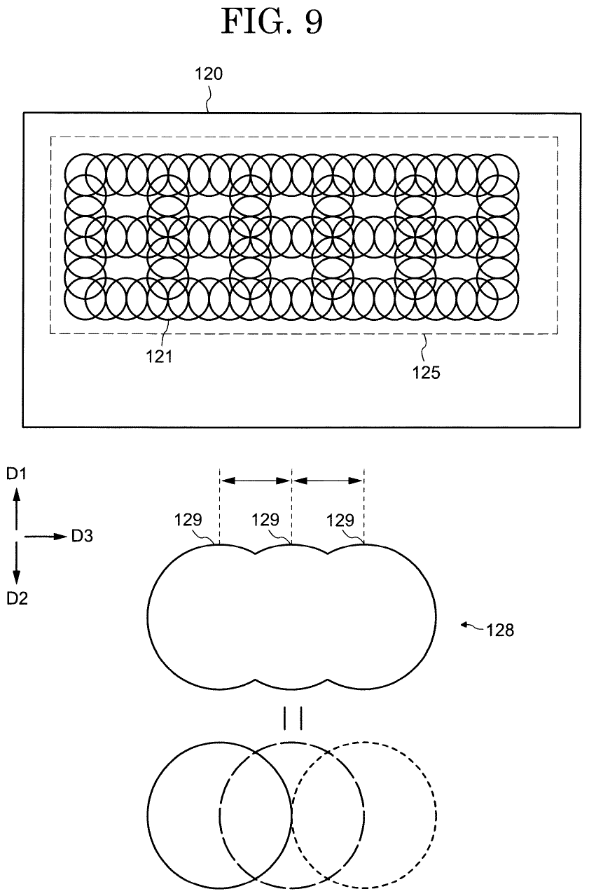

A modification of the present embodiment will be described with reference to FIG. 9 to FIG. 11. FIG. 9 is a partially enlarged view of a laser irradiation portion of a top surface material of a key in an embodiment of the present disclosure. In FIG. 9, unlike FIG. 7, adjacent recesses 121 overlap each other in a plan view. As shown in FIG. 9, in the case where adjacent recesses 121 overlap each other, they actually appear as a continuous shape, such as a planar shape 128. Even in such a case, it can be said that the recesses 121 are arranged periodically based on some periodic shapes. Specifically, it can be determined that the recesses 121 are periodically arranged based on periodicity of upper portions 129 of the plurality of recesses 121 overlapping each other shown in FIG. 9.

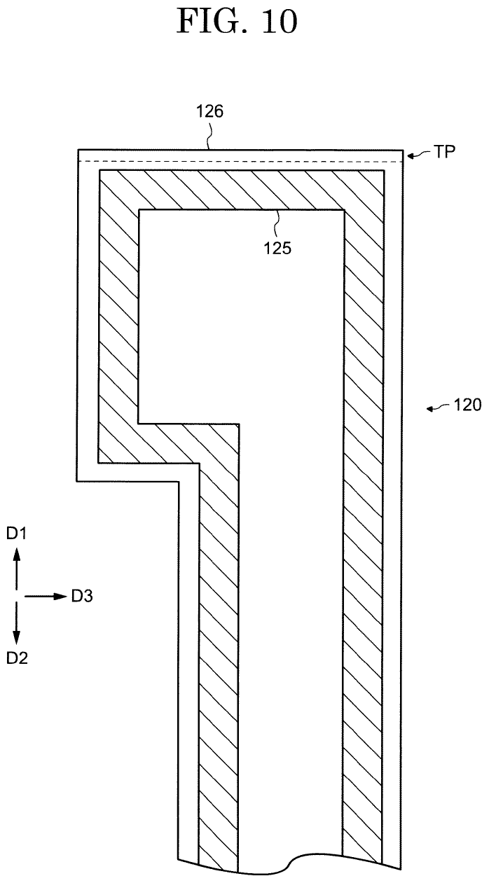

FIG. 10 is a diagram showing a laser irradiation portion of a top surface material of a key according to an embodiment of the present disclosure. In FIG. 10, unlike FIG. 6, the unevenness forming region 125 is provided not only near the tip 126 of the key upper surface portion 120 but also along a periphery of the key upper surface portion 120. As shown in FIG. 10, the unevenness forming region 125 may be continuously provided along the periphery of the key upper surface portion 120, or may be discretely provided along the periphery.

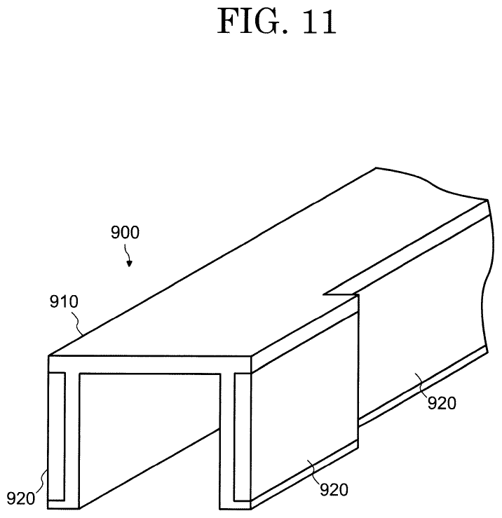

FIG. 11 is a perspective view of a key according to a modification of the embodiment of the present disclosure. A white key 900 shown in FIG. 11 is, for example, a white key used in an electronic piano. In the white key 900, a key body portion 910 is made of a resin material, and a key side surface portion 920 is made of wood. The key body portion 910 is integrally formed by resin molding. A recess is formed in a side surface of the key body portion 910. The key side surface portion 920 is plate-shaped wood, and is bonded so as to be fitted into a recess of the key body portion 910.

Even with such a configuration, the key body portion 910, which is a resin material, is provided with the same shape as the recess 121 and the uneven shape 122 shown in FIG. 4 and FIG. 5, whereby the adhesion strength between the key body portion 910 and the key side surface portion 920 can be improved.

Even in the modification described above, the same effects as those of the present embodiment can be obtained.

The present disclosure is not limited to the embodiments described above, and can be appropriately modified without departing from the scope of the present disclosure.

What is claimed is:

1. A key for a keyboard apparatus, the key comprising:
a key body portion made of wood;
a key upper surface portion made of resin positioned on an upper surface of the key body portion; and
an adhesive material bonding the key body portion and the key upper surface portion,
wherein a lower surface of the key upper surface portion includes a recess portion including a plurality of recesses, and
wherein each recess has an uneven shape.

2. The key according to claim 1, wherein:
a width of each recess is 20 μm or more and 500 μm or less, and
a difference in height of at least part of the uneven shape is 20 μm or more.

3. The key according to claim 2, wherein each recess includes:
a visible region that is visible as viewed from the lower side of the key upper surface portion; and
a non-visible region that is positioned overlapping part of the visible region and thus not visible as viewed from the lower side of the key upper surface portion.

4. The key according to claim 1, wherein the adhesive material is a water soluble adhesive material.

5. The key according to claim 1, wherein:
the recess portion is disposed in an unevenness forming region of the key upper surface portion, and
the plurality of recesses are periodically arranged in the unevenness forming region along a width direction and a length direction of the key upper surface portion.

6. The key according to claim 5, wherein:
the unevenness forming region is arranged at a first part of the lower surface of the key upper surface portion, and
a second part of the lower surface of the key upper surface portion that is different from the first part is flat.

7. The key according to claim 6, wherein the unevenness forming region is disposed 3 mm or more away from a tip of the key upper surface portion in the length direction.

8. The key according to claim 7, wherein:
a tip region of the lower surface of the key upper surface portion protrudes in the length direction from a tip of the key body portion, and
the unevenness forming region does not extend to the tip region.

9. A key for a keyboard apparatus comprising:
a key body portion made of wood;
a key upper surface portion made of resin positioned on an upper surface of the key body portion; and
an adhesive material bonding the key body portion and the key upper surface portion,
wherein a lower surface of the key upper surface portion includes:
a visible region that is visible as viewed from the lower side of the key upper surface portion; and
a non-visible region that is positioned overlapping the visible region and thus not visible as viewed from the lower side of the key upper surface portion.

10. The key according to claim 9, wherein:
the lower surface of the key upper surface portion includes a recess portion including a plurality of recesses, and
each recess has an uneven shape.
